(19) United States
(12) Patent Application Publication
(10) Pub. No.: US 2002/0174235 A1
(43) Pub. Date: Nov. 21, 2002

(54) Method and apparatus for providing prepaid internet services

(76) Inventor: George Likourezos, Brooklyn, NY (US)

Correspondence Address: George Likourezos, 9321 Ridge Boulevard, Brooklyn, NY, 11209, US

(21) Appl. No.: 10/103,344

(22) Filed: Mar. 21, 2002

Related U.S. Application Data
(60) Provisional application No. 60/277,724, filed on Mar. 21, 2001.

(51) Int. Cl. G06F 15/16

(52) U.S. Cl. 709/228

(57) ABSTRACT

The present invention provides a method and apparatus for pre-paying for Internet access time. After pre-paying, the apparatus is used to access the Internet for receiving Internet content, as well as performing Internet services, such as sending/receiving e-mail. The apparatus includes a processor programmed with instructions for providing a predetermined amount of Internet access time. Hence, when the user purchases the apparatus, the user in effect pre-pays for a predetermined amount of Internet access time. The processor is programmed, for example, to provide 30 hours of Internet access time, thereby enabling the user to access the Internet for 30 hours before the apparatus is cut-off from the Internet. The processor or other device, such as an internal clock, is programmed to clock Internet usage time, either forwards or backwards, and to cut-off the Internet connection when a predetermined time is reached. If the predetermined time is not reached during an individual Internet session, the processor stores the clocked time and/or available Internet access time. When the user re-connects to the Internet, the processor retrieves the stored clocked time and/or available Internet access time and clocks the remaining time. This process continues until the clocked time is equal to the predetermined time stored within the processor. At this time, the Internet connection is disabled. The apparatus can also be used for programming the processor with additional Internet access time by connecting to a remote server and purchasing additional Internet access time, or by inserting within the apparatus a prepaid Internet access card or a prepaid Internet access smart card storing a predetermined amount of Internet access time.

### PRIORITY

This application claims priority to a United States Provisional Application filed on Mar. 21, 2001 titled “Apparatus and System For Providing Prepaid Internet Services” and assigned U.S. Provisional Application Serial No. 60/277,724, the contents of which are incorporated herein by reference.

### BACKGROUND OF THE INVENTION

Access to the Internet is generally available to a user by subscribing to an Internet Service Provider (ISP) and paying a monthly access fee. The access fee is typically charged to the subscriber's credit card.

Another method of accessing the Internet entails purchasing a prepaid Internet access card which includes a personal identification number or PIN. The user then accesses a remote server and enters the PIN. The remote server verifies the PIN and if valid, determines the amount of Internet access time available to the user. The remote server then gives the user access to the Internet. While the user has access to the Internet, the remote server clocks the user's Internet access time. If the user's Internet access time exceeds the available Internet access time over one or several Internet sessions, the remote server disables the Internet connection.

The present invention provides methods and an apparatus for providing prepaid Internet services.

### SUMMARY OF THE INVENTION

The present invention provides a method and apparatus for pre-paying for Internet access time. After pre-paying, the apparatus is used to access the Internet for receiving Internet content, as well as performing Internet services, such as sending/receiving e-mail. The apparatus includes an input port, e.g., a telephone jack connector, and associated Internet connection software, i.e., a web browser, stored within a processor for non-wirelessly connecting the apparatus to the Internet or other network. The apparatus also includes a keyboard and a display for displaying Internet content and other information to the user. The apparatus also includes an antenna and associated hardware/software for wirelessly connecting the apparatus to the Internet or other network for receiving Internet content transmitted via a cellular network, satellite network system, PSTN, and/or other RF transmission system.

The processor of the apparatus is pre-programmed with instructions for providing a predetermined amount of Internet access time. Hence, when the user purchases the apparatus, the user in effect pre-pays for a predetermined amount of Internet access time. The processor is programmed, for example, to provide 30 hours of Internet access time, thereby enabling the user to access the Internet for 30 hours before the apparatus is cut-off from the Internet.

The processor or other device, such as an internal clock, is programmed to clock Internet usage time, either forwards or backwards, and to cut-off the Internet connection when a predetermined time is reached. If the predetermined time is not reached during an individual Internet session, the processor stores the clocked time and/or available Internet access time. When the user re-connects to the Internet, the processor retrieves the stored clocked time and/or available Internet access time and clocks the remaining time. This process continues until the clocked time is equal to the predetermined time stored within the processor. At this time, the Internet connection is disabled. Further, the user is also prevented from connecting to the Internet using the apparatus, unless additional time is purchased.

### BRIEF DESCRIPTION OF THE DRAWINGS

Various embodiments of the invention will be described hereinbelow with reference to the drawings wherein:

FIG. 1 illustrates a perspective diagram of the apparatus in accordance with the present invention;

FIG. 2 illustrates a block diagram of the functional blocks of the apparatus shown by FIG. 1; and

FIG. 3 illustrates a system incorporating the apparatus shown by FIG. 1 in accordance with the present invention.

### DETAILED DESCRIPTION OF THE PREFERRED EMBODIMENTS

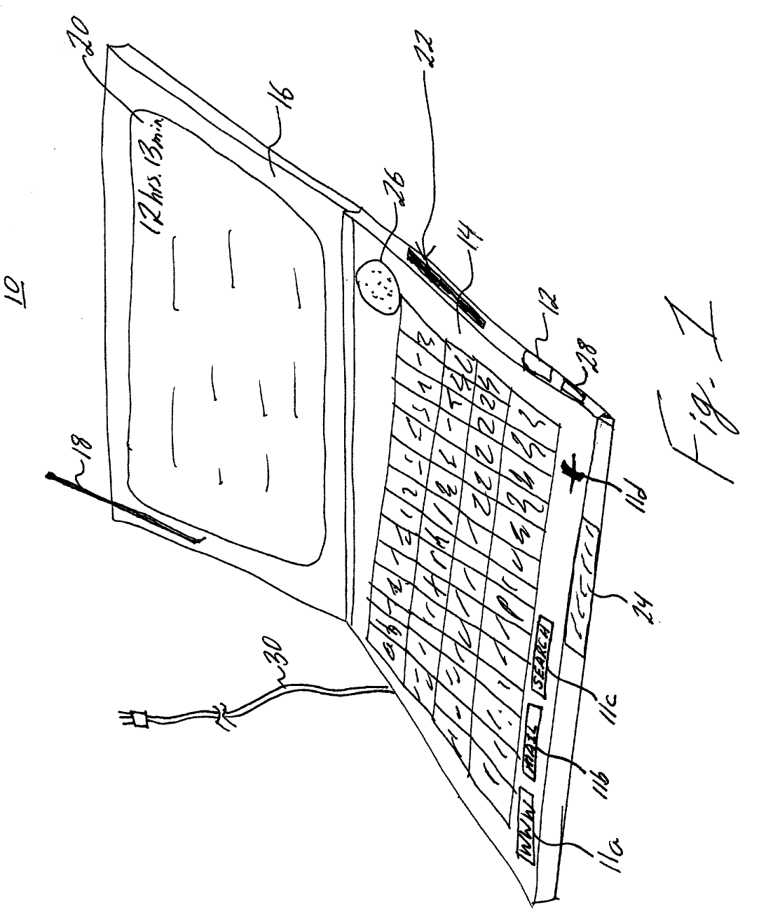

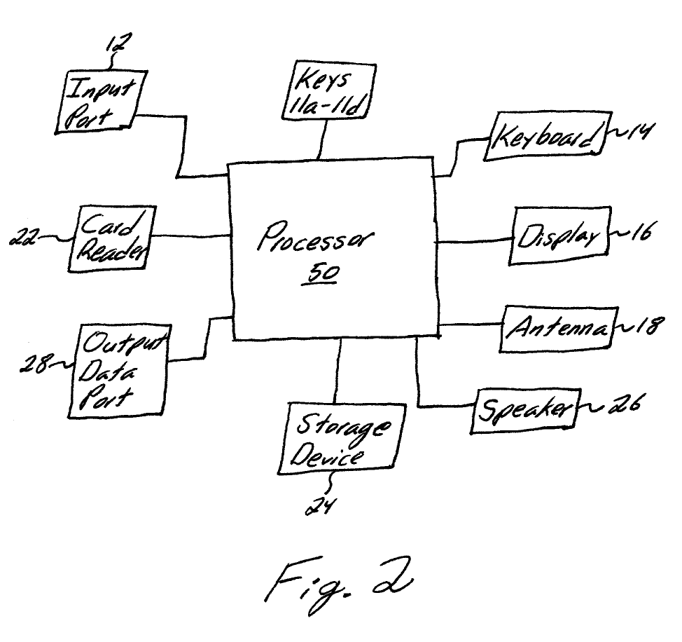

With reference to FIG. 1, the present invention provides an apparatus designated generally by reference numeral 10. The apparatus 10 is a client-side apparatus configured for accessing, either wirelessly or non-wirelessly, the Internet and for providing Internet content, as well as Internet services, such as e-mail, to a user. The apparatus 10 includes an input port 12, e.g., a telephone jack connector, and associated Internet connection software, i.e., a web browser, stored within a processor 50 (FIG. 2) for non-wirelessly connecting the apparatus 10 to the Internet or other network. The apparatus 10 also includes a keyboard 14 and a display 16 for displaying Internet content and other information to the user.

The apparatus 10 further includes an Internet connection key 11a which upon being pressed initiates an Internet connection process for connecting the apparatus 10 to the Internet. The apparatus 10 also includes an e-mail key 11b which upon being pressed displays an e-mail window on the display 16 for managing one's e-mail account(s), i.e., viewing e-mails, sending emails, deleting e-mails, etc. The apparatus 10 also includes a search key 11c which upon being pressed displays a search window on the display 16 for entering a query to perform a search over the Internet. The apparatus also includes a scroll knob 11d for scrolling the contents displayed on the display 16 by rotating the scroll knob 11d.

The apparatus 10 further includes an antenna 18 and associated hardware/software for wirelessly connecting the apparatus to the Internet or other network for receiving Internet content transmitted via a cellular network, satellite network system, PSTN, and/or other RF transmission system. It is contemplated that the antenna 18 and associated hardware/software connect to these networks/systems by one of the following standards: IEEE 802.11, 3G, and Bluetooth.

The processor 50 of the apparatus 10 is pre-programmed with instructions to provide a predetermined amount of Internet access time. Hence, when the user purchases the apparatus 10, the user in effect pre-pays for a predetermined amount of Internet access time. The processor 50 is programmed, for example, to provide 30 hours of Internet access time, thereby enabling the user to access the Internet for 30 hours before the apparatus 10 is cut-off from the Internet.

The processor 50 or other device, such as an internal clock, is programmed to clock Internet usage time, either forwards or backwards, and to cut-off the Internet connection when a predetermined time is reached. If the predetermined time is not reached during an individual Internet session, the processor 50 stores the clocked time and/or available Internet access time.

When the user re-connects to the Internet, the processor 50 retrieves the stored clocked time and/or available Internet access time and clocks the remaining time. This process continues until the total amount of clocked time is equal to the predetermined time stored within the processor 50. At this time, the Internet connection is disabled. Further, the user is also prevented from connecting to the Internet using the apparatus 10, until additional time is purchased as described below.

As an example of the operation of the apparatus 10, the processor 50 clocks Internet usage time forwards, from zero time to, for example, 30 hours to use the above example. When the processor 50 clocks 30 hours, the processor 50 determines that this is the predetermined time by comparing the 30 hours to the predetermined time stored within the processor 50. The processor 50 then transmits an Internet cut-off signal. If the user logs off or disconnects from the Internet before the processor 50 clocks the predetermined time, the processor 50 stores the clocked time. It is contemplated that the processor 50 rounds-up the clocked time to the next minute before storing the clocked time. For example, if the clocked time is five minutes and twenty-five seconds, the stored clocked time would be six minutes.

When the user re-connects to the Internet, the processor 50 retrieves the stored clocked time and/or available Internet access time and clocks the remaining time. This process continues until the actual or rounded clocked time (or components thereof) is equal to the predetermined time stored within the processor 50, upon which time the Internet connection is disabled.

The processor 50 can also determine that 30 hours is the predetermined time by being programmed not to be able to clock past 30 hours and to transmit the Internet cut-off signal when 30 hours have been clocked. The Internet cut-off signal cuts-off the Internet connection by disabling the operation of the input port 12 and/or the antenna 18, or by some other means.

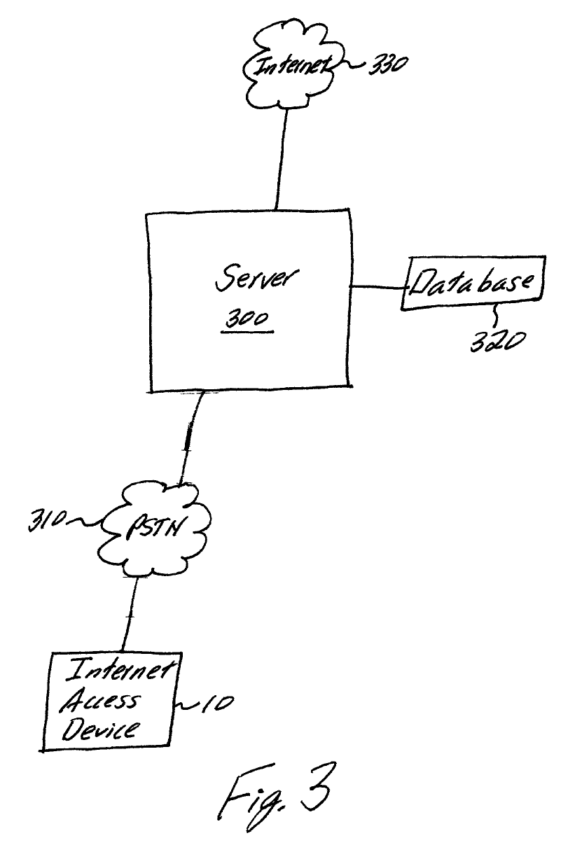

The Internet connection can also be cut-off by having the processor 50 transmit a cut-off signal to a remote server 300 (FIG. 3) or other non-client side computing device associated with an Internet Service Provider (ISP) or other Internet provider/operator. The cut-off signal includes an identification code corresponding to the particular apparatus 10. The remote server 300 identifies via the identification code the particular apparatus 10 and stops providing Internet services to that apparatus 10 by permanently or temporarily unsubscribing the user.

In an alternate embodiment of the present invention, as shown by the system illustrated by FIG. 3, the remote server 300 or other computing device associated with the ISP or other Internet provider/operator clocks and stores the amount of time the apparatus 10 is connected to the Internet, instead of the processor 50. The remote server 300 disables the Internet connection when the remote server 300 clocks a time approximately equal or equal to the predetermined amount of Internet access time allocated to the apparatus 10.

In this embodiment, the remote server 300 identifies the apparatus 10 by an identification process every time the apparatus 10 is connected to the Internet. For example, the identification process can entail that the apparatus 10 transmit an identification signal via the PSTN network 310 (or one or more other networks) to the remote server 300 during the Internet log-in process. The identification signal includes an identification code which the remote server 300 uses to identify the apparatus 10 using a look-up table or other data structure stored in a database 320.

The remote server 300 then uses the same data structure or another data structure stored within the database 320 to retrieve the previous clocked time for that apparatus 10, if any. If there is Internet access time still available for the apparatus 10, the remote server 300 connects the apparatus 10 to the Internet 330. During the time that the apparatus 10 is connected to the Internet 330, the remote server 300 clocks the available Internet access time.

When the user disconnects from the Internet 330, the processor 50 transmits the identification signal once again to the remote server 300. The remote server 300 then overwrites the previous clocked time stored within the database 320 with the current clocked time. It is provided that the remote server 300 also transmits to the database 320 the available Internet access time. It is further provided that the database 320 can be an external database in operative communication with the remote server 300 as shown by FIG. 3 or an internal database stored within the remote server 300 and/or the apparatus 10.

It is contemplated that the remote server 300 rounds-up the clocked time to the next minute before storing the clocked time within the database 320. For example, if the clocked time is five minutes and twenty-five seconds, the stored clocked time would be six minutes. When the actual or rounded clocked time equals the predetermined amount of Internet access time during the Internet session, the remote server 300 disconnects the apparatus 10 from the Internet 330.

In either embodiment, it is contemplated for the processor 50 or the remote server 300 to be pre-programmed with instructions to notify the user via the display 16 or other means prior to cutting-off or disabling the Internet connection. For example, the user can be notified by a message on the display 16 stating, “Less than five minutes of Internet access time is available.”The display 16 can also continuously or upon receiving a command from the user display the amount of available Internet access time 20 and/or the amount of Internet access time already used.

Further, in either embodiment, the processor 50 or remote server 300 provides the user with the opportunity to purchase additional Internet access time by entering credit card information or other payment information and transmitting this information to the ISP or other Internet provider/operator. It is contemplated that this feature is available to the user even after the Internet connection has been cut-off or disabled. Hence, the user can purchase additional Internet access time after the user has used up all of the predetermined Internet access time.

The apparatus 10 also includes a magnetic/smart card reader 22 for swiping a prepaid Internet access card storing thereon a predetermined amount of Internet access time or inserting a prepaid Internet access smart card therein. In the case of swiping the prepaid Internet access card, the magnetic/smart card reader 22 deducts or reads the Internet access time stored on the prepaid Internet access card and transmits the Internet access time to the processor 50. The processor 50 is then programmed with the Internet access time for providing Internet access to the user as described above. The processor 50 appends the stored Internet access time with the Internet access time stored by the prepaid Internet access card.

In the case of inserting a prepaid Internet access smart card having a microprocessor programmed with a predetermined amount of Internet access time, the reader 22 interfaces with the prepaid Internet access smart card. After the user logs-on to the Internet, a signal is transmitted from the processor 50 or other component to the microprocessor instructing the microprocessor to clock the Internet access time stored within the microprocessor. This process occurs every time the user logs-on to the Internet, until the actual or rounded clocked time (or components thereof) is equal to the predetermined Internet access time as originally stored within the microprocessor, upon which time the Internet connection is disabled by the processor 50 and/or the microprocessor generating an Internet cut-off signal. The Internet cut-off signal cuts-off the Internet connection by disabling the operation of the input port 12 and/or the antenna 18, or by some other means.

In the alternate embodiment, the Internet access time read from the prepaid Internet access card or prepaid Internet access smart card is transmitted to the remote server 300 during the log-on process or some other time, since in this embodiment the remote server 300, instead of the processor 50 or microprocessor, clocks the Internet access time as described above. Preferably, the Internet access time read from the prepaid Internet access card or prepaid Internet access smart card is transmitted to the remote server 300 via the identification signal.

It is contemplated that the prepaid Internet access card or prepaid Internet access smart card is left within the magnetic/smart card reader 22 during an Internet session. As such, the user's internet session, i.e., URL's of web sites accessed, and other information, e.g., information associated with received and transmitted e-mails, Internet accessed stock quotes, and Internet accessed driving directions, can then be stored within the prepaid Internet access card or prepaid Internet access smart card for retrieval at a future time by the apparatus 10 or other computing device.

Further, since the prepaid Internet access card or prepaid Internet access smart card is left within the magnetic/smart card reader 22, the actual or rounded clocked time and/or available Internet access time, following the Internet session, is stored within the prepaid Internet access card or prepaid Internet access smart card. Accordingly, the prepaid Internet access card or prepaid Internet access smart card can be used at a later time with the same apparatus 10 or another apparatus 10.

The apparatus 10 further includes a storage device 24 for storing Internet content therein. It is provided that the Internet content that is stored within the storage device 24 is not erased when the Internet connection is cut-off, i.e., when the user is permanently or temporarily unsubscribed by the ISP. The apparatus 10 also includes a speaker 26 for listening to streaming audio signals and other audio information transmitted over the Internet.

The apparatus 10 also includes an output data port 28 for non-wirelessly transferring data from the apparatus 10 to a personal computer or other electronic device, such as a printer or storage device. Accordingly, the apparatus 10 can be used to access the Internet and transmit Internet content to an external storage device, cellular telephone, printer, PDA, personal computer, or other computing device via the output data port 28, during the Internet session or at a future time. The output data port 28 can be used to output data stored within the prepaid Internet access card, prepaid Internet access smart card, and storage device 24. It is contemplated that the apparatus 10 can include components for wirelessly transferring data from the apparatus 10 to a personal computer or other electronic device.

The apparatus 10 is powered by plugging the apparatus 10 to an electrical wall outlet via an electrical power cord 30. The apparatus 10 can also be solar-powered and/or battery-powered for making the apparatus 10 mobile.

The display 16, speaker 26, processor 50 and other electrical components of the apparatus 10 are preferably provided on one or more inexpensive materials, such as paper (cellulose-containing material), fabric, and synthetic material (nylon, plastic, etc.), and interconnected therebetween for making the apparatus 10 disposable and inexpensive. Accordingly, the apparatus 10 is well suited for the traveler who desires to access the Internet at will and does not want to carry a laptop or have to search for an available computer. The apparatus 10 is also well suited for individuals who do not own a computer and desire Internet services.

It is provided that the present invention instead of clocking an Internet connection time, subtracts a token, etc. for each predetermined time period. For example, the present invention can include 100 Internet access tokens, where a token is subtracted for every five minutes of actual or rounded Internet access time. Hence, in effect, the present invention includes 500 minutes of Internet access time (100 Internet access tokens times five minutes) and, in essence, clocks the Internet connection. In this scheme, the display 16 displays the number of available Internet access tokens and/or the number of used Internet access tokens.

It is provided that the processor 50, the prepaid Internet access card, and the prepaid Internet access smart card include a set of programmable instructions configured for being executed by at least the processor 50 and the microprocessor for performing the various functions and methods described herein.

The claims which follow seek to cover the described embodiments and their equivalents. The concept in its broadest scope covers the method and apparatus for providing prepaid Internet services. It is readily apparent to those having ordinary skill in the art to which it appertains that changes and modifications may be made thereto without departing from the spirit or scope of the subject invention as defined by the appended claims.

I claim:

1. An apparatus for accessing the Internet for no more than a predetermined period of time, the apparatus comprising:
means for establishing an Internet connection;
means for receiving Internet content via the Internet connection;
means for timing an Internet connection time corresponding at least in part with the Internet connection; and
means for disabling the Internet connection when the Internet connection time is equal to the predetermined period of time.

2. The apparatus according to claim 1, further comprising means for storing the timed Internet connection time and/or available Internet access time if the Internet connection is disconnected prior to the Internet connection time being equal to the predetermined period of time.

3. The apparatus according to claim 2, wherein the means for storing stores Internet content received via the Internet connection.

4. The apparatus according to claim 1, further comprising means for displaying the Internet connection time and/or an amount of Internet access time available.

5. The apparatus according to claim 1, further comprising means for providing additional Internet access time to the apparatus.

6. The apparatus according to claim 5, wherein the means for providing additional Internet access time includes means for receiving an Internet access card storing Internet access time.

7. The apparatus according to claim 6, wherein the means for timing and means for disabling are provided on the Internet access card.

8. The apparatus according to claim 6, further comprising means for appending the predetermined period of time with the Internet access time.

9. The apparatus according to claim 1, further comprising means for transferring data from the apparatus to an external computing device.

10. The apparatus according to claim 1, wherein the means for establishing, the means of receiving, the means for timing, and the means for disabling are provided on one or more materials selected from the group consisting of paper, fabric, and synthetic materials.

11. An apparatus comprising:
means for accessing the Internet for no more than a predetermined period of time; and
means for receiving Internet content while at least accessing the Internet.

12. The apparatus according to claim 11, further comprising means for programming the accessing means for accessing the Internet for more than the predetermined period of time.

13. A method for providing Internet access for no more than a predetermined period of time, the method comprising the steps of:
establishing an Internet connection for providing Internet services to a user of a client-side apparatus;
timing an Internet connection time corresponding at least in part with the Internet connection; and
disabling the Internet connection when the Internet connection time is equal to the predetermined period of time, wherein the steps of establishing, timing and disabling are performed at least by the client-side apparatus.

14. The method according to claim 13, further comprising the step of storing the timed Internet connection time and/or available Internet access time if the Internet connection is disconnected prior to the Internet connection time being equal to the predetermined period of time.

15. The method according to claim 13, further comprising the step of storing Internet content received via the Internet connection within the client-side apparatus.

16. The method according to claim 13, further comprising the step of displaying the Internet connection time and/or an amount of Internet access time available on a display of the client-side apparatus.

17. A method for providing Internet access comprising the steps of:
receiving an identification code corresponding to an Internet access device via an Internet connection;
identifying the Internet access device via the identification code;
determining an amount of Internet access time available for the identified Internet access device;
timing an Internet connection time corresponding at least in part with the Internet connection; and
disabling the Internet connection when the Internet connection time is equal to the determined amount of available Internet access time.

18. The method according to claim 17, further comprising the step of storing the timed Internet connection time and/or available Internet access time if the Internet connection is disconnected prior to the Internet connection time being equal to the determined amount of available Internet access time.

19. The method according to claim 18, wherein the step of storing the timed Internet connection time and/or available Internet access time includes the step of transmitting the timed Internet connection time and/or available Internet access time to the Internet access device for storing therein.

20. The method according to claim 17, further comprising the step of appending the determined amount of available Internet access time with additional Internet access time.
